(19) United States
(12) Patent Application Publication
(10) Pub. No.: US 2007/0170218 A1
(43) Pub. Date: Jul. 26, 2007

(54) Apparatus for transporting refuse cans

(76) Inventor: Patrick M. Robb, Granville, OH (US)

Correspondence Address: MILLER & BARNS, PLLC, 230 EAST BROADWAY, SUITE 250, GRANVILLE, OH, 43023, US

(21) Appl. No.: 11/339,395

(22) Filed: Jan. 25, 2006

(51) Int. Cl. B60R 9/00; B60R 11/00

(52) U.S. Cl. 224/519; 224/533; 224/525

(57) ABSTRACT

The present invention provides for the safe and easy transport of refuse cans such as standard residential refuse cans. The invention is a device that may be removably attached to a vehicle to receive a refuse can for transport. The present invention includes a removably mountable refuse can transport device that is mounted to a vehicle by a hitch engagement such as an insert to a conventional trailer hitch, a vertical support mounted with a base that supports a refuse can and a locking plate that rotates to retain a refuse can on the base to allow convenient transport of the refuse can. In one preferred embodiment of the present invention a lock and release control member is coupled to the locking plate. In an alternate embodiment of the invention the refuse can transporting includes a support frame that temporary attaches to a motor vehicle, an articulated support on the frame which moves up and down to move a retaining bracket into and out of engagement with a refuse can. Preferably, the retaining bracket includes a first side for contacting a refuse can and a second side for releasably retaining a refuse can and a spring for drawing the bracket up to retain the refuse can. Preferably, the refuse can sits on a support mounted on a lower end of the supporting frame during transport.

### TECHNICAL FIELD AND INDUSTRIAL

The present invention relates to a device for transporting refuse cans that is simple to use. More particularly, the invention relates to an apparatus for transporting a standard residential refuse can. Even more particularly, the invention is directed to a device that may be removably attached to a vehicle to receive a refuse can for transport.

### BACKGROUND OF THE INVENTION

In recent years, household refuse collection services have encouraged the use of wheeled, lidded refuse cans typically having a capacity of 65 to 94 gallons or more. The use of these cans allows the operator of a refuse collection truck to use a hydraulic lift to raise the can to dump refuse into the truck. As shown in FIG. 5, and disclosed in U.S. Pat. No. 5,826,485 (herein incorporated by reference in its entirety) a lifting apparatus 20 for dumping a refuse can 26 may be mounted on a rear bumper 24 of a refuse collection truck 22. The refuse can 26 typically includes a detent or engagement surface 30 and often includes a second engagement surface 32 by which the refuse can 26 is raised so that the refuse may be dumped into the opening 28 in the refuse truck 22. Lifting apparatus 20 commonly includes a face plate 34 for clearance between the bottom portion 36 of the lifting apparatus 20 and the road surface 38. By using apparatus 20, the operator only needs to position the refuse can 26 and operate a hand valve 40 to hydraulically lift the refuse can 26. The hydraulic lift improves the efficiency and ease of collecting refuse and decreases injuries to refuse collectors related to lifting the heavy cans 26.

While these cans are convenient for the operator of a refuse truck, they are larger than conventional refuse cans and can be difficult for a homeowner to transport the larger refuse cans to the street for trash collection. This problem is especially pronounced in rural areas where the distance the refuse can must be transported can be great.

One conventional system that simplifies the transport of large refuse cans is the “Trash Caddy”. In the “Trash Caddy”, the can is tilted down so that the handle of the can engages one of two hooks extending from a beam that are secured to the receiver hitch of a vehicle. The “Trash Caddy” has several drawbacks, however, including the difficulty of raising and lowering a full refuse can. Large 96-gallon refuse cans typically have a rated capacity of 250 pounds. Additionally, the “Trash Caddy” relies on the wheels of the refuse can to support the weight of the can during transport. Typically, the wheels are not designed for long distance transport and can either be bent, damaged, or worn during extended transport.

Other mechanisms for transporting materials or refuse cans have been designed, as discussed below. However, each of these alternative designs has one or more drawbacks including: high cost to manufacture, exposed pinch points, reliance on spring mechanisms or slow rotating crank mechanisms.

U.S. Pat. No. 2,338,955 to Hollis H. Metcalf discloses an automobile carrier mounted on the rear bumper and trunk of a vehicle. The lift mechanism is rotatable around a fulcrum such that the lift mechanism is pivoted up toward the vehicle after loading.

U.S. Pat. No. 6,033,178 discloses a transporter for a refuse can that includes a support frame mounted on a vehicle and an articulating frame mounted to the support frame that is capable of reciprocal upward and downward movement by operation of a hand lever attached to both the support and the articulating frame. Springs are positioned between the two frames to provide a mechanical advantage in lifting the refuse can.

U.S. Pat. No. 6,361,264 discloses a transporter for a refuse can that includes a post with a track, a lifter supported on the post which moves longitudinally to both raise and lower the refuse can. The '264 Patent also discloses upper and lower wheeled trucks which ride on the track within the post and which are attached to the lifter with a cable and a rotatable lift handle to raise and lower the refuse can.

U.S. Pat. No. 6,698,995 discloses a structure similar to that of U.S. Pat. No. 6,361,264 but with a telescoping mount and a lead screw on the post. The lead screw is connected to the telescoping mount for raising and lowering the telescoping mount.

Although there are many refuse transporting devices for transporting refuse cans in existence, an apparatus for transporting refuse cans that has a low manufacturing cost and that possesses ease and speed in use without the reliance on springs or cranks is much sought after. Accordingly, there is a need for a safe, strong, and easy-to-use refuse can transport apparatus.

### SUMMARY OF THE INVENTION

The invention of the present invention includes a removably mountable refuse can transport device that is mounted to a vehicle by a hitch engagement such as an insert to a conventional trailer hitch, a vertical support mounted with a base that supports a refuse can and a locking plate that rotates to retain a refuse can on the base to allow convenient transport of the refuse can. In one preferred embodiment of the present invention a lock and release control member is coupled to the locking plate. In an alternate embodiment of the invention the refuse can transporting includes a support frame that temporary attaches to a motor vehicle, an articulated support on the frame which moves up and down to move a retaining bracket into and out of engagement with a refuse can. Preferably, the retaining bracket includes a first side for contacting a refuse can and a second side for releasably retaining a refuse can and a spring for drawing the bracket up to retain the refuse can. Preferably, the refuse can sits on a support mounted on a lower end of the supporting frame during transport.

### BRIEF DESCRIPTION OF THE DRAWINGS

FIG. 1 is a plan view of a device for transporting refuse cans in accordance with the present invention in which the transporting device is mounted on a vehicle in preparation for engagement with a refuse can.

FIG. 2 is a plan view of a device for transporting refuse cans in accordance with the present invention in which the transporting device is mounted on a vehicle and engaged with a refuse can.

FIG. 2A is a plan view of a device for transporting refuse cans in accordance with the present invention in which the transporting device is mounted on a vehicle and is in the process of releasing engagement with a refuse can.

FIG. 3 is a partial plan view of a device for transporting refuse cans in accordance with the present invention.

FIG. 4 is an exploded perspective view of a device for transporting refuse cans in accordance with the present invention.

FIG. 5 is a perspective view of a refuse truck with an attached lifting system and a refuse can in accordance with the prior art.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent application, issued U.S. or foreign patents, or any other references, are each incorporated by reference in their entireties, including all data, tables, figures, and text presented in the cited references. In the drawings, the thickness of the lines, layers, and regions may be exaggerated for clarity. It is to be noted that like numbers found throughout the figures denote like elements.

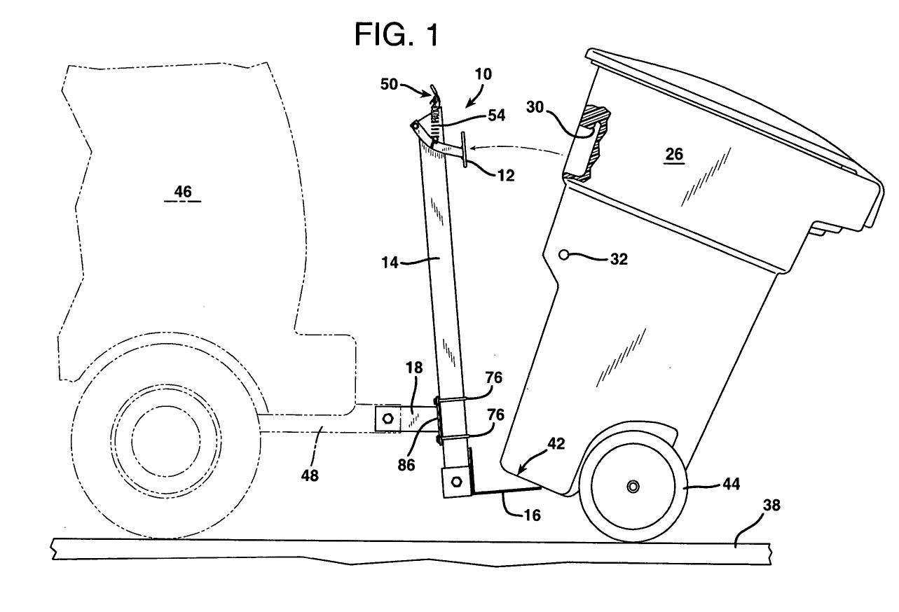

In order to develop a safe, strong, and easy-to-use refuse can transport apparatus. the present invention provides a mechanism which may be quickly and easily installed and removed on a vehicle and which secures a refuse can safely and securely. Turning to FIG. 1, the refuse can transport apparatus 10 may be installed into a hitch mount 48 of a vehicle 46 or, alternatively, it may be installed over a standard ball hitch (not shown). The vehicle 46 shown in FIG. 1 includes a hitch receiver 48 into which a receiver insert 18 is received. The hitch receiver insert 18 may include a hitch plate 86 to which an upright support 14 may be retained by square U-bolts 76. At the base of the upright support 14 is a base 16 for supporting a refuse can 26. At the upper end of the upright support 14 is a locking plate 12 that may be moved from a lock position to a release position by lever 50 and spring 54. FIG. 1 shows the lever 50 in the ‘up’ position which draws the locking plate 12 upwardly and into the lock position.

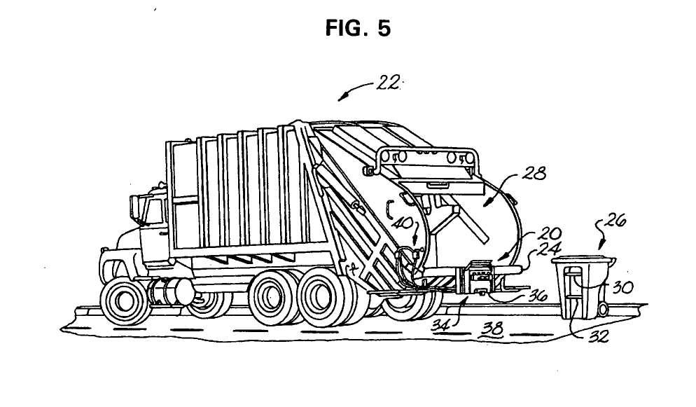

As seen in FIG. 1, the refuse can 26 includes an engagement member 30 and optionally a second engagement member 32. The engagement member 30 is typically in the form of a bar (as shown in FIG. 5) or a detent (as shown in FIG. 1). The refuse can 26 also includes a lower surface 42 and wheels 44.

In order to transport the refuse can 26, the refuse can transport apparatus 10 can is mounted on vehicle 46 and the refuse can 26 is positioned adjacent the to the apparatus 10. The refuse can 26 is then rotated back and pushed forward until the lower surface 42 of the refuse can 26 engages the base member 16 of the apparatus 10. The can is then rotated upward (arrow) such that the weight of the refuse can 26 is supported by the base 16.

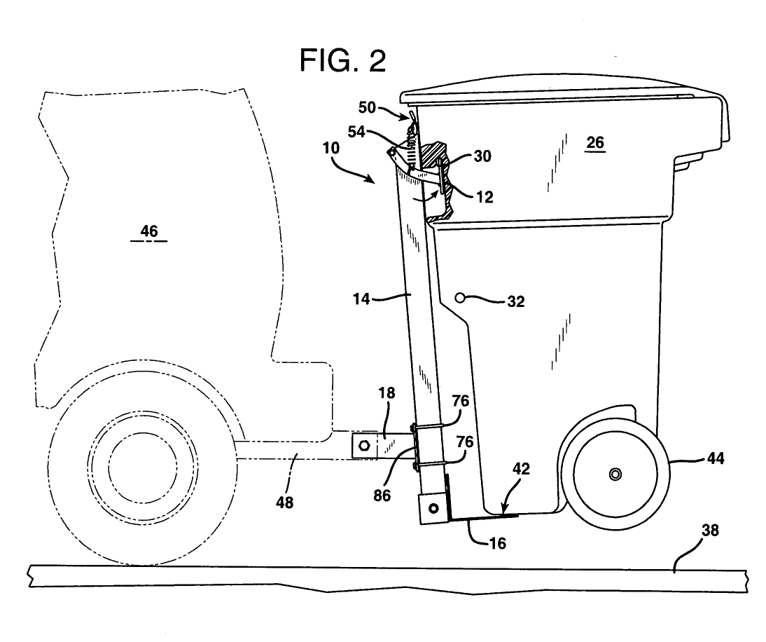

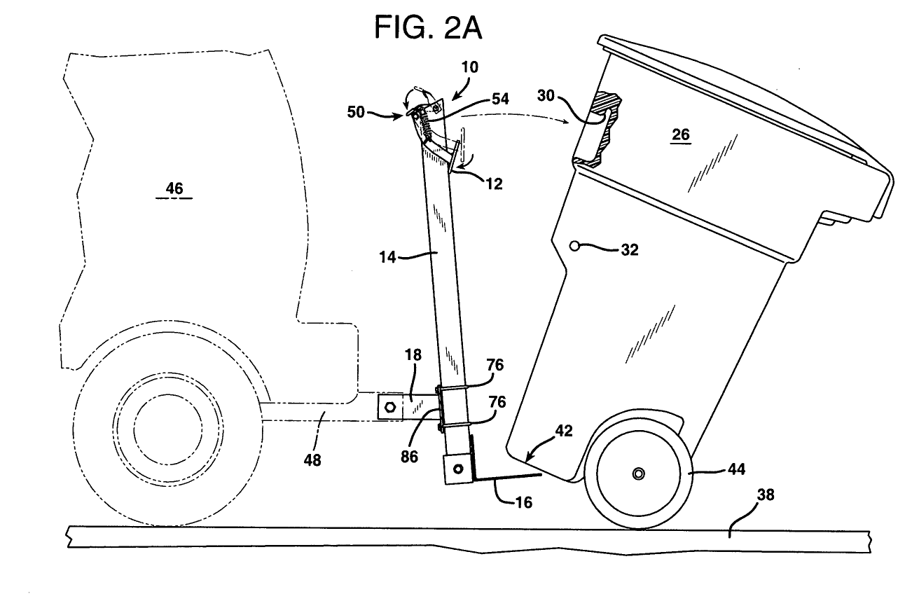

As shown in FIG. 2 the engagement 30 of refuse can 26 contacts the locking plate 12 to retain the refuse can 26 safely and securely on the apparatus for transport. The locking plate 12 is urged upwardly (arrow) by spring 54 to rotate to secure the engagement member 30. As shown in FIG. 2, with the lever 50 in the up position, the operator pushes engagement member 30 of the refuse can 26 into the spring-loaded locking plate 12 causing plate 12 to lower sufficiently to slide under engagement member 30. The locking plate 12 is then drawn upward into the engagement member 30 of the can. The locking plate 12 secures the engagement 30 whether the engagement 30 is a detent (shown in FIG. 2) or a bar (shown in FIG. 5). Once the refuse can 26 is safely locked onto the transport apparatus, the vehicle 46 may be driven to the desired location for trash removal and the refuse can 26 may be quickly and easily released.

The release of the refuse can 26 is shown in FIG. 2A. In order to release the can, the locking lever 50 is moved to the release position. In the release position, the spring 54 no longer urges the locking plate 12 upwardly and into the engagement member 30. However, the weight of the refuse can 26 retains the locking plate 12 in the lock position. To release the locking plate, the operator simply pushes the refuse can 26 toward the apparatus 10 which removes the force from the locking plate 12, thereby allowing the plate 12 to fall to the release position (as shown by the solid arrow in FIG. 2A). The refuse can 26 may then be lowered to the ground (as shown by the dashed arrow in FIG. 2A) and left for refuse collection.

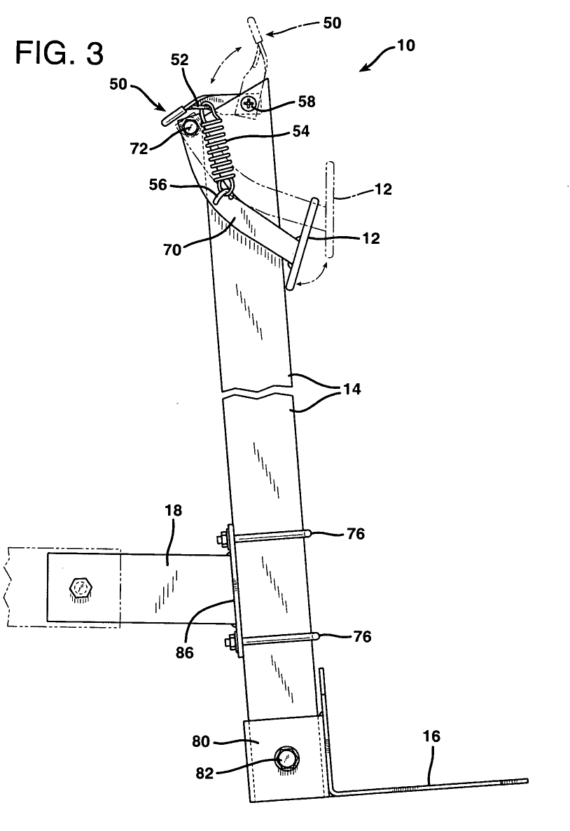

FIG. 3 shows a detailed view of a refuse can transport device 10 in accordance with the present invention. The refuse can transport apparatus 10 preferably includes a hitch receiver insert 18 which may be coupled to a hitch receiver 48 of a vehicle. In order to adjust the height of the apparatus 10, a hitch plate 86 and square U-bolts 76 are provided which allow the apparatus 10 to be raised or lowered depending upon the terrain over which a refuse can 26 is to be transported. While it is preferred that the apparatus 10 be as low as possible to ease the loading and unloading of the refuse can 26, the apparatus 10 may be raised to account for a steep or uneven surface 38 of a driveway or road.

The apparatus also preferably includes a main upright support 14 and a base 16 for supporting a refuse can 26 (not illustrated in FIG. 3) at the lower end of the main upright support 14. At the upper end of the main upright support 14 is a locking mechanism that engages the refuse can 26 so that the refuse can 26 may be transported safely and easily. The locking mechanism in accordance with one embodiment of the present invention includes a plate 12 that is moved from an upper ‘lock’ position to a lower ‘release’ position by a lever 50 and a spring 54. By rotating the lever 50 upwardly about the screw 58, the spring 54 is placed in tension and the locking plate 12 is drawn up and into the lock position. When the locking plate 12 contacts the engagement member 30 of the refuse can 26, the locking plate is forced downwardly to pass under the engagement member 30 of the refuse can 26. The base 16 may be fixed directly to the upright support 14 or, preferably, the base 16 may be mounted to a base connector 80 attached to support 14 by bolt 82.

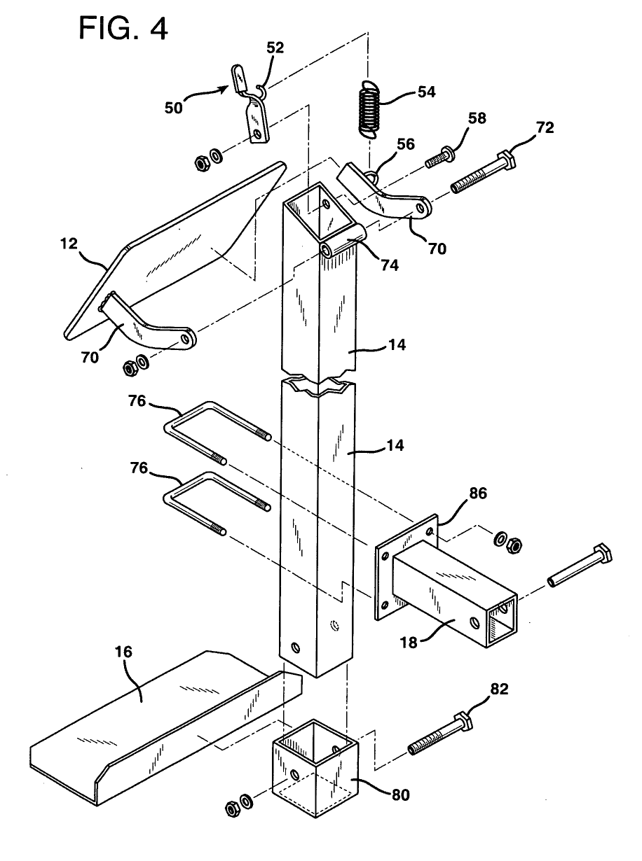

As shown in the exploded view of FIG. 4, one preferred construction of the apparatus 10 of the present invention includes an upright support 14 having upper and lower ends. A locking mechanism at the upper end includes a lever 50 for locking and releasing a lock plate 12. Lever 50 is mounted by a bolt 58 and includes a hook 52 for engaging a spring 54. The lock plate 12 is rotatably mounted to the upright support 14 by arms 70 and axis bolt 72, which passes through a hinge plate 74. The central portion of the upright member 14 is attached to a hitch receiver insert 18 by a hitch plate 86. Square U-bolts 76 allow the vertical adjustment of the apparatus 10 relative to the ground. At the lower end of the vertical member 14 is a base 16 for supporting the weight of the can. The base 16 is mounted to a base connector 80 and attached to the upright member 14 by a bolt 83.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

I claim:

1. A removably mountable refuse can transport device, comprising:
a hitch engagement for engaging a vehicle;
a vertical support mounted on the hitch engagement;
a base on a lower end of the vertical support for receiving a refuse can; and
a rotatable locking plate rotatably connected to an upper end of the vertical support having a lock position for retaining the refuse can on the base and a release position for releasing the refuse can from the base;
wherein the refuse can may be received on the base and rotated upward to engage the rotatable locking plate and be retained on the base.

2. The refuse can transport device of claim 1, further comprising:
a lock and release control member coupled to the rotatable locking plate for changing the rotatable locking plate from a locked position to a released position.

3. The refuse can transport device of claim 2, further comprising:
an extendible coupler positioned between the lock and release control member and the rotatable locking plate.

4. The refuse can transport device of claim 3, wherein the extensible coupler is a spring.

5. The refuse can transport device of claim 3, wherein the extensible coupler draws the rotatable locking plate upward and into a locked position in preparation for engagement with an engagement mechanism on the refuse can; and
wherein the locking plate is maintained in the locked position during transport of a refuse can.

6. The refuse can transport device of claim 2, wherein the locking plate is retained in the locked position by the weight of an engaged refuse can until the weight of the engaged refuse can is removed from the locking plate and the locking plate is released from an engagement mechanism on the container to allow disengagement of the engaged refuse can from the transport device.

7. The refuse can transport device of claim 1, further comprising a rotatable support for the locking plate, the rotatable support being mounted on the upper end of the vertical support and operable to move the rotatable locking plate from a locked position to a released position.

8. The refuse can transport device of claim 1, further comprising:
a hitch plate positioned between the vertical support and the hitch engagement to allow vertical adjustment of the base.

9. A refuse can transporting device comprising:
a supporting frame for temporary attachment to a motor vehicle;
an articulated support coupled to the supporting frame, the articulated support being capable of reciprocal upward and downward movement;
a retaining bracket mounted on the articulating support for engagement with a refuse can, the retaining bracket including a first side for contacting a refuse can and a second side for releasably retaining a refuse can; and
a base support mounted on a lower end of the supporting frame for supporting the refuse can.

10. The refuse can transporting device of claim 9, further comprising:
an extensible member for drawing the retaining bracket into a retaining position;
wherein the refuse can may be received on the base and rotated upwardly to engage the retaining bracket and be retained on the transport device.

11. The refuse can transporting device of claim 10, further comprising:
an actuator for releasing the tension in the extensible member.

12. The refuse can transporting device of claim 11, wherein the actuator is a hand lever coupled to the supporting frame and to the articulated support.

13. The refuse can transporting device of claim 11, wherein the actuator is a hand lever coupled to the supporting frame to control movement of the retaining bracket between a retaining position and a released position.

14. The refuse can transporting device of claim 10, wherein the retaining bracket remains in the retaining position when loaded by a refuse can.

15. The refuse can transporting device of claim 14, wherein the retaining bracket is released from the retaining position when the refuse can is pushed toward the supporting frame.

16. The refuse can transporting device of claim 11, wherein the retaining bracket remains in the retaining position when loaded by a refuse can and is released when the refuse can is pushed toward the supporting frame.

17. A vehicle mounted container transport device, comprising:
an upright support having upper and lower ends;
at least one rotatable arm mounted on the upright support;
a movable retaining bracket mounted on the at least one rotatable arm; a locking mechanism at the upper end of the upright support, the locking mechanism having a lever and a spring for locking and releasing the retaining bracket;
a base mounted on the upright support for supporting a container.

18. The vehicle mounted container transport device of claim 17, further comprising:
a hitch receiver insert mounted to the upper end of the upright support, the hitch receiver insert allowing for vertical adjustment of the upright member relative to the ground.

19. The vehicle mounted container transport device of claim 18, wherein the hitch receiver insert includes a hitch plate and U-bolts.

20. The vehicle mounted container transport device of claim 17, wherein the at least one rotatable arm includes first and second rotatable arms mounted on opposing sides off the upright member at the upper end of the upright support.
